(19) United States
(12) Patent Application Publication
(10) Pub. No.: US 2014/0047099 A1
(43) Pub. Date: Feb. 13, 2014

(54) PERFORMANCE MONITOR FOR MULTIPLE CLOUD COMPUTING ENVIRONMENTS

(71) Applicants: Romelia H. Flores, Coppell, TX (US); Leonard S. Hand, Rochester, NY (US)

(72) Inventors: Romelia H. Flores, Coppell, TX (US); Leonard S. Hand, Rochester, NY (US)

(73) Assignee: INTERNATIONAL BUSINESS MACHINES CORPORATION, Armonk, NY (US)

(21) Appl. No.: 13/570,193

(22) Filed: Aug. 8, 2012

(51) Int. Cl. G06F 15/173

(52) U.S. Cl. 709/224

(57) ABSTRACT

A system and method for monitoring the performance of cloud computing environments. The system includes provider multi-cloud monitors configured in cloud computing environments and a consumer multi-cloud monitor configured in a cloud consumer computer. The consumer multi-cloud monitor retrieves performance data on the cloud computing environments from the provider multi-cloud monitors, converts and analyzes the cloud performance data in view of service level agreements, and presents cloud performance results to a user.

### FIELD OF THE INVENTION

The invention relates generally to cloud computing, and more particularly, to monitoring the performance of multiple cloud computing environments from one or more cloud consumer computers.

### BACKGROUND

Cloud computing allows business enterprises to quickly deploy computing resources and applications to service their customers without setting up and maintaining costly data centers. Instead, the business enterprises can focus on their core business and leave the operation and maintenance of the computing resources to the cloud computing providers. Cloud consumers may receive computing services from a cloud provider's data centers that include pools of computing resources such as servers, data storage, networks, and software applications. The cloud provider may offer these resources to the cloud consumers as on-demand and fee-based services. Cloud computing services are typically delivered to the consumers through a combination of private and public networks, such as company intranets and the Internet.

A cloud provider and a could consumer generally have a service level agreement (SLA) in place that specifies the computing service requirements that the cloud provider is expected to provide to the cloud consumer, such as the availability of the cloud services and time delay between when a problem is reported and when it is resolved. The SLA insures the availability of the cloud services to support the cloud consumer's business operation and that service problems are quickly resolved to minimize impact to the cloud consumer's operation.

A cloud consumer may receive cloud services under multiple SLAs and from different providers of the cloud environments.

It is desirable for a cloud consumer to be able to monitor the performance of multiple cloud environments offered by different providers and to track multiple cloud service level agreements (SLAs).

### BRIEF SUMMARY

Embodiments of the invention relate to monitoring the performance of cloud computing environments and tracking service level agreements between the cloud providers and cloud consumers. The embodiments of the invention may be implemented as a stand-alone cloud computing utility or integrated into computing system performance utilities.

One aspect of the invention concerns a multi-cloud monitor system comprising provider multi-cloud monitors configured in multiple cloud computing environments to obtain performance data on the cloud computing environments; a consumer multi-cloud monitor configured in a cloud consumer computer to retrieve cloud performance data from the provider multi-cloud monitors; and a user interface coupled to the consumer multi-cloud monitor to present the cloud performance data to a user.

Another aspect of the invention concerns a computer-implemented method for monitoring the performance of cloud computing environments. The method may comprise configuring provider multi-cloud monitors in multiple cloud computing environments to obtain performance data on the cloud computing environments; configuring a consumer multi-cloud monitor in a cloud consumer computer to obtain cloud performance data from the provider multi-cloud monitors; periodically retrieving the cloud performance data from the provider multi-cloud monitors; converting the cloud performance data into a format for analysis; analyzing the converted cloud performance data; and presenting the analyzed cloud performance data to a user.

A further aspect of the invention concerns a computer program product for monitoring the performance of cloud computing environments. The computer program product comprises a computer readable storage medium readable by a computer and embodying program instructions executable by the computer to configure provider multi-cloud monitors in multiple cloud computing environments to obtain performance data on the cloud computing environments; configure a consumer multi-cloud monitor in a cloud consumer computer to obtain cloud performance data from the provider multi-cloud monitors; periodically retrieve the cloud performance data from the provider multi-cloud monitors; convert the cloud performance data into a format for analysis; analyze the converted cloud performance data; and present the analyzed cloud performance data to a user.

The details of the preferred embodiments of the invention, both as to its structure and operation, are described below in the Detailed Description section in reference to the accompanying drawings. The Summary is intended to identify key features of the claimed subject matter, but it is not intended to be used to limit the scope of the claimed subject matter.

### BRIEF DESCRIPTION OF THE DRAWINGS

FIG. 1 illustrates a networked computer configuration in which embodiments of the invention may be implemented.

FIG. 2 illustrates an example configuration of a multi-cloud monitor deployed in multiple cloud computing environments to monitor the performance of cloud computing environments from a cloud consumer computer.

FIG. 3 illustrates an example embodiment of a multi-cloud monitor for monitoring the performance of multiple cloud computing environments from a cloud consumer computer.

FIG. 4 illustrates an example multi-cloud monitor user screen that displays performance information on the cloud computing environments, from which a cloud consumer may select display options to view additional details on the performance of the cloud computing environments.

FIG. 5 illustrates an example multi-cloud monitor user screen that displays cloud availability and incident details for a service level agreement between a cloud provider and a cloud consumer.

FIG. 6 is a flow chart of an example process for setting up multi-cloud monitor components in the cloud computing environments and in a consumer computer to monitor the performance of the cloud computing environments.

FIG. 7 illustrates an example computer system which may be configured to provide the components and functions of the multi-cloud monitor.

### DETAILED DESCRIPTION

The invention is described in exemplary embodiments in the following description with reference to the Figures, in which like numbers represent the same or similar elements. While the invention is described through the embodiments for achieving the invention's objectives, it will be appreciated by those skilled in the art that variations may be accomplished in view of these teachings without deviating from the spirit or scope of the invention.

The present disclosure relates to a system, computer-implemented method, and computer program product for monitoring the performance of cloud computing environments and tracking service level agreements between the cloud providers and cloud consumers. In one embodiment, components of a multi-cloud monitor may be deployed in the cloud computing environments and a cloud consumer's computer to allow the cloud consumer to view performance characteristics of the cloud computing environments. The consumer may further examine details about a particular service level agreement as to how well the cloud provider is meeting service requirements as specified in the service level agreement. The components of the multi-cloud monitor may be configured in computer hardware, software, or a combination of computer hardware and software.

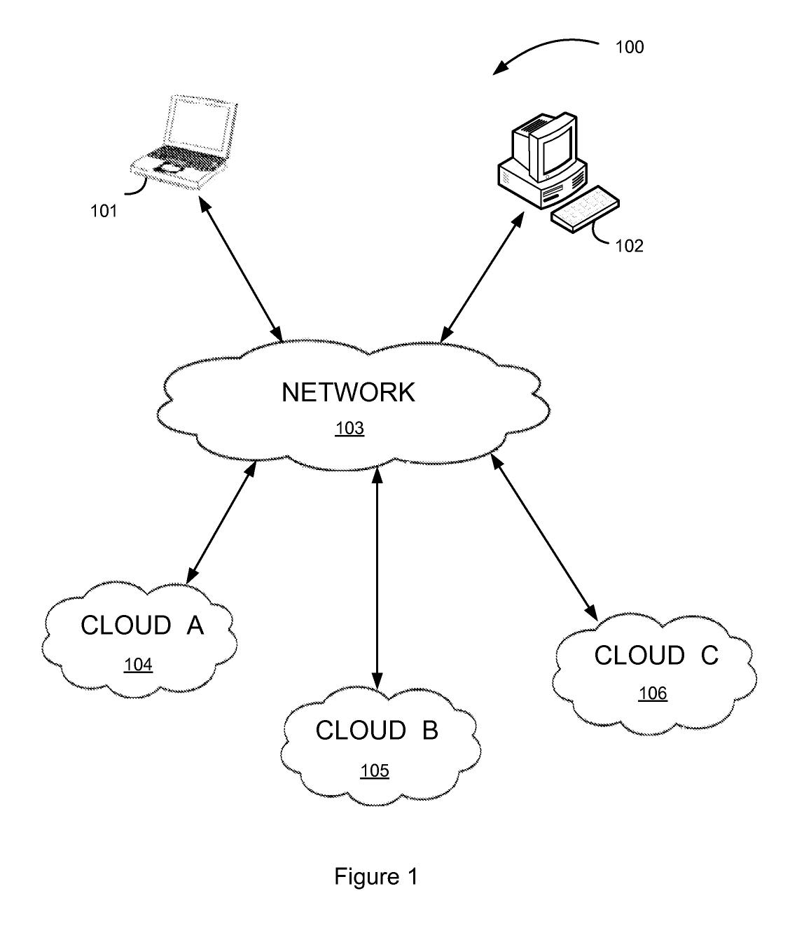

Referring to FIG. 1, there is illustrated a block diagram of a cloud computing configuration 100 to which example embodiments of the present application may be applied. The cloud computing configuration 100 may include multiple cloud environments 104-106 from which the consumers of the cloud environments may receive cloud computing services. Each of the cloud environments 104-106 is typically a pool of computing resources that include servers, memory, data storage, computer networks, virtual machines, services, and software applications, e.g., financial applications. These computing resources may be configured on demand based on the needs of a cloud consumer and delivered to the consumer as a measured service through network 103.

Cloud computing enables different service models such as the Software as a Service (SaaS) model, the Platform as a Service (PaaS) model, and the Infrastructure as a Service (IaaS) model. Cloud computing itself can be deployed according to a number of deployment models such as the private cloud model, community cloud model, public cloud model, and hybrid cloud model.

Each cloud computing environment 104-106 may include one or more cloud computing nodes that the cloud consumer computers 101-102 may communicate with. The nodes communicate with one another and may be grouped together physically or virtually. The cloud computing environments 104-106 offer infrastructure, platforms and software as services for which a cloud consumer does not need to maintain resources on a local computing device.

The cloud consumers may access the computing services from the cloud environments 104-106 through network 103. The consumer computers 101-102 may be on-site at a cloud consumer premise or at a remote location connected to a cloud consumer premise by wired or wireless networks. Network 103 between cloud consumer computers 101-102 and provider cloud environments 104-106 may be one or more public or private networks, or a combination thereof. The network 103 may further comprise wired or wireless networks, or a combination thereof.

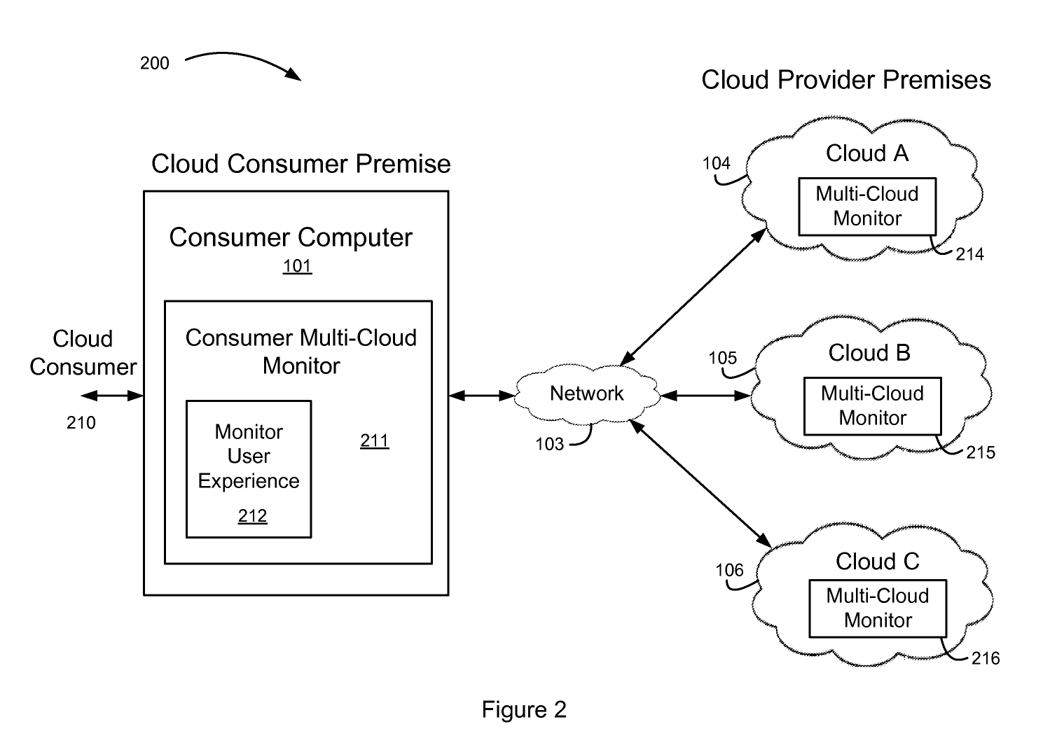

FIG. 2 illustrates an example configuration of a multi-cloud monitor system 200 that is deployed in multiple cloud computing environments 104-106 to monitor the performance of the cloud environments 104-106 from a cloud consumer computer 101. In one embodiment, the cloud environments 104-106 may be monitored from multiple cloud consumer computers 101 located at different cloud consumer facilities. The multi-cloud monitor system 200 includes components that may be deployed at the consumer premises and the provider premises. These components work together to collect information on the performance of the cloud computing environments 104-106, such as how a cloud provider is meeting the service level agreements that specify the required service levels to be delivered to the cloud consumers.

In one embodiment, the multi-cloud monitor system 200 includes a consumer multi-cloud monitor 211 that operates on a cloud consumer computer 101, which may be located on the consumer's premise or remotely connected to the consumer's computer infrastructure through a network. Cloud consumer 210 may interact with the consumer multi-cloud monitor 211 through a monitor user experience 212 which provides the cloud consumer 210 with user interface screens for viewing performance data on the cloud computing environments 104-106.

The multi-cloud monitor system 200 further includes provider multi-cloud monitors 214-216 that are respectively deployed in the cloud providers' computing environments 104-106 to monitor the performance of the cloud computing environments 104-106, obtain performance data on the cloud computing environments 104-106, and provide the consumer multi-cloud monitor 211 with the performance data.

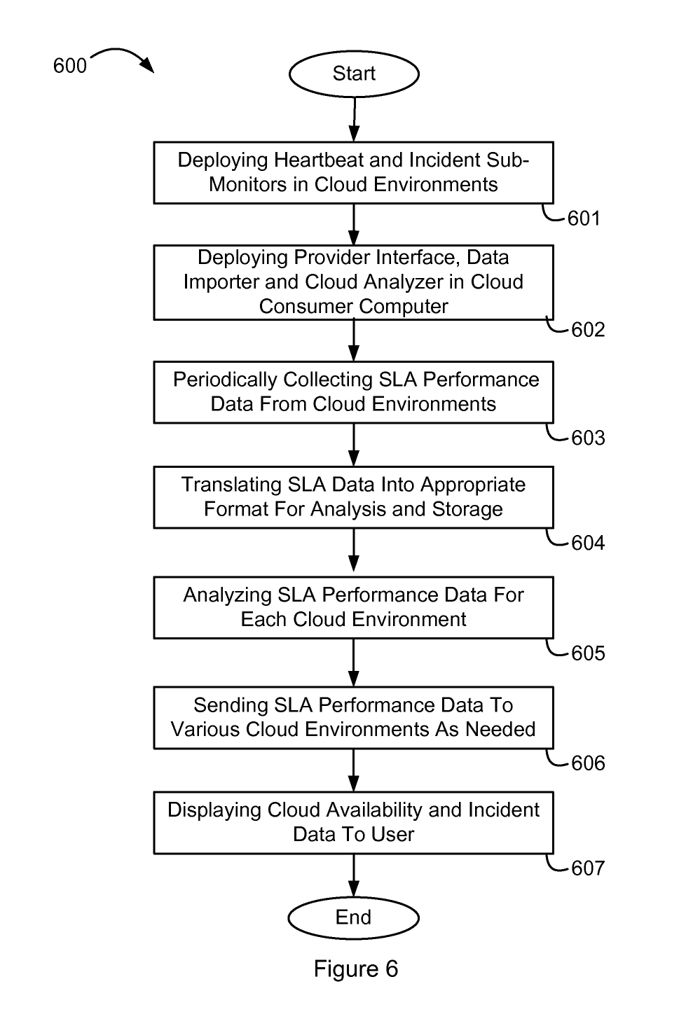

The cloud computing environments 104-106 may be pools of computing resources such as servers, data storage, and software applications that operate at the data centers on the cloud provider premises. As described with reference to FIG. 1, the cloud consumer computer 101 may be connected to the cloud computing environments 104-106 through network 103. Through the network 103, the consumer multi-cloud monitor 211 operating on the consumer computer 101 may retrieve, from the provider multi-cloud monitors 214-216, performance data on the cloud environments 104-106. The cloud consumer 210 may view the retrieved cloud performance data and inquire for additional details on the performance of the clouds, as needed, through the monitor user experience 212. Details of an example process for collecting and presenting the cloud performance data to the cloud consumer 210 are described below with reference to FIG. 6.

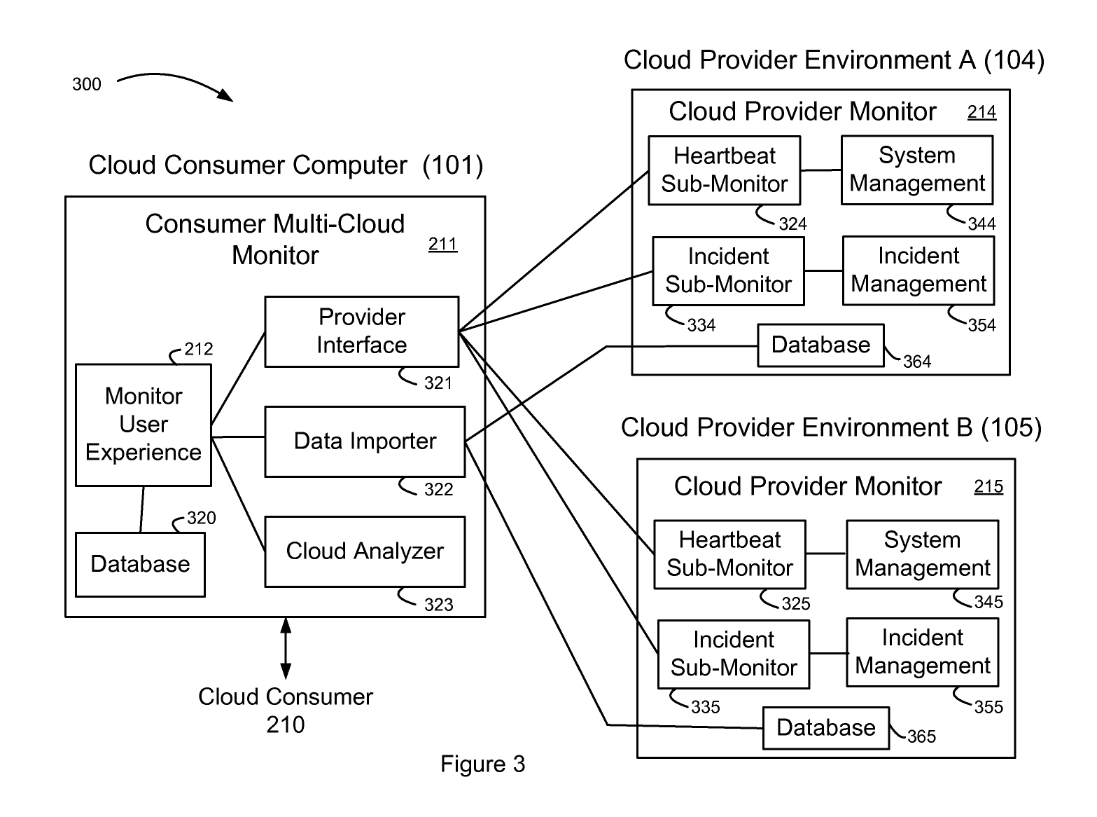

FIG. 3 illustrates an example embodiment of a multi-cloud monitor system 300 for monitoring the performance of two cloud computing environments A (104) and B (105) from a cloud consumer computer 101. The consumer multi-cloud monitor 211 that operates on a cloud consumer computer 101 may include a monitor user experience component 212 which manages the overall operation of the consumer multi-cloud monitor 211 and interfaces with other components of the consumer multi-cloud monitor 211. The monitor user experience component 212 is responsible for displaying cloud performance information obtained from the various cloud environments to the consumer 210. Further, the monitor user experience component 212 can be configured to receive information from one or more provider cloud computing environments 104-106 and is mapped for display to the cloud consumer 210.

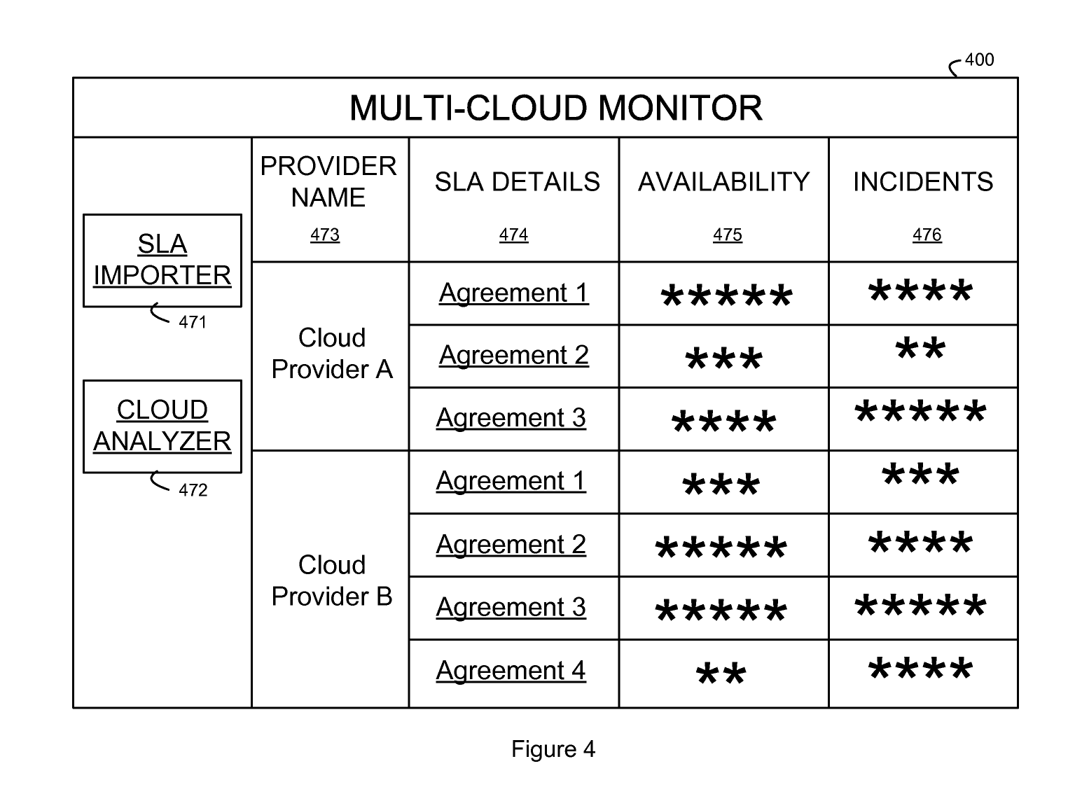

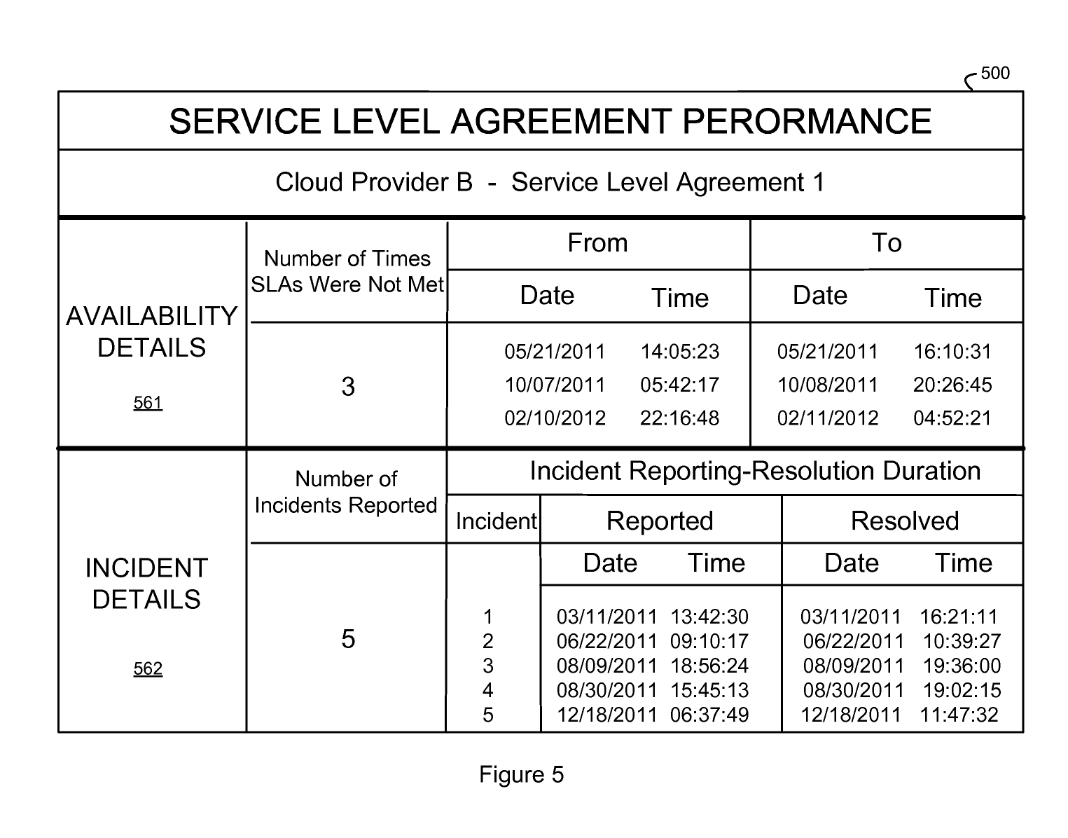

The cloud performance information obtained from the provider cloud environments 104-106 may include information on the service level agreements (SLAs) serviced by each cloud provider, the level of operation for each cloud provider, as well as the number of incidents reported to each cloud provider. The SLA information is imported from the components of the multi-cloud monitor system 300 that are deployed in the cloud environments 104-106. In one embodiment, the monitor user experience component 212 may provide a dashboard view of the cloud environments 104-106 as described below with reference to FIGS. 4-5. In one embodiment, the monitor user experience component 212 may be implemented as a computer program that runs in the cloud consumer computer 101.

The consumer multi-cloud monitor 211 may include a provider interface component 321 for communicating with the multi-provider multi-cloud monitors 214-215 that are respectively deployed in the cloud computing environments 104-105. The provider interface 321 may periodically pull information from all instances of the provider multi-cloud monitors 214-215 deployed in the cloud computing environments 104-105. In one embodiment, the provider interface 321 receives information from heartbeat sub-monitors 324-325 and incident sub-monitors 334-335 that are deployed in the provider multi-cloud monitors 214-215, as described below. The function of the provider interface 321 is to ensure appropriate mapping from the information being obtained from the heartbeat sub-monitors 324-325 and incident sub-monitors 334-335 to a local data store 322 accessed by the consumer multi-cloud monitor 211.

The consumer multi-cloud monitor 211 may further include a data importer 322 for retrieving performance data on the cloud computing environments 104-106 periodically or as needed by the user. The data importer 322 enables the retrieval of SLA information from multiple cloud computing environments 104-106 that the cloud consumer 210 has negotiated with the providers of the cloud computing environments 104-106. SLA information is an agreement typically in a document format that is the agreed-to plan between a cloud provider and a cloud consumer regarding the operation of the cloud environment. It is generally made available by a cloud provider to a cloud consumer.

A cloud computing provider can also make available historical information regarding IT operations levels and incidents which have been submitted by a consumer and the status of the incidents. In one embodiment, SLA information may be in the form of word documents. These word documents can be modified by the user to and it is the function of the data importer 322 to translate the SLA information into appropriate XML format.

Once the performance data is retrieved by the consumer multi-cloud monitor 211 via the provider interface 321, the data can be converted into a suitable format and stored in database 320. The data stored in database 320 is the foundation of analytical data available to the cloud analyzer 323. Analysis of this information can yield comparisons of the various provider environments 214 and 215 and how they are performing against their specific service level agreements. Additional predictive analytics can also be leveraged to determine which provider environment is having greater success in meeting SLAs and which provider environments should be considered over a particular time period for additional agreements to be needed by the cloud consumer. The cloud analyzer 323 provides the consumer 210 with insight regarding which cloud computing environments 104-106 they should focus on re-negotiation for new SLAs or request cost cuts due to low performance against SLAs. Cloud performance data is consolidated by the consumer multi-cloud monitor 211 for all cloud computing environments 104-106 being monitored via the provider multi-cloud monitors 214-215. The consolidated data is utilized by the cloud analyzer 323 to perform deeper analysis of the various cloud computing environments 104-106.

The analysis performed by the cloud analyzer 323 may include information about particular cloud service providers that a cloud consumer 210 should consider given a new cloud computing environment to be negotiated, or what new SLAs should the consumer 210 be negotiating for with a particular cloud service provider. The retrieved cloud performance data and results of the cloud analysis may be stored in local database 320 for further tabulation and display to the user.

In the cloud environments A (104) and B (105) illustrated in FIG. 3, each of the provider multi-cloud monitors 214-215 may include a heartbeat sub-monitor 324-325 and an incident sub-monitor 334-335. The heartbeat sub-monitors 324-325 are responsible for supplying the consumer multi-cloud monitor 211 (at the cloud consumer computer 101) with information on how each specific cloud computing environment 104-105 is performing, via the provider interface 321. The cloud performance information from the heartbeat sub-monitors 324-325 and incident sub-monitors 334-335 may be in the form of XML data that flows between two or more cloud environments.

In one embodiment, the heartbeat sub-monitors 324-325 and incident sub-monitors 334-335 may be respectively coupled to the cloud providers' system management and incident management utilities (e.g., service desk utilities). For example, the heartbeat sub-monitors 324-325 may communicate with corresponding cloud system management components 344-345 in the cloud computing environments 104-105. The incident sub-monitors 334-335 may communicate with respective cloud incident management components 354-355 in the cloud computing environments 104-105. In one embodiment, the cloud system management components 344-345 and cloud incident management components 354-355 may be integrated into the provider multi-cloud monitors 214-215, as illustrated. In another embodiment, cloud system management components 344-345 and cloud incident management components 354-355 may operate in the cloud computing environments 104-105, but outside the provider multi-cloud monitors 214-215.

The cloud provider multi-cloud monitors 214-215 may include local databases 464-465 that maintain details on the service level agreements between the cloud providers and the cloud consumers. The system management components 344-345, incident management components 354-355, and provider databases 364-365 are parts of the cloud computing environments 104-105 that the cloud provider monitors 214-215 can be integrated into.

FIG. 4 illustrates an example multi-cloud monitor user screen 400 that provides a cloud consumer 210 with performance data of the cloud computing environments at a high level, from which the cloud consumer 210 may obtain more details as needed. The multi-cloud monitor user screen 400 may be a dashboard that lists the names 473 of the cloud computing providers and the service level agreements (SLAs) 474 that are serviced by each of the cloud computing providers. A cloud consumer 210 can select an “SLA Importer” hot link 471 to view detailed information regarding a particular service level agreement that is serviced by a particular cloud provider.

At a glance, the cloud consumer 210 can see information on cloud availability ratings 475 and incident ratings 476 that indicate how well a cloud provider is meeting the expectations of a particular SLA that the cloud provider is servicing. For example, cloud provider B is meeting all requirements for platform availability and incident reporting of the service level agreement 3. From the dashboard view 400, the cloud consumer 210 can select “Agreement” hot links under SLA Details 472 to view detailed availability information obtained by the heartbeat sub-monitors 324-325 and detailed incident information obtained by the incident sub-monitors 334-335. Availability information may include the number of times that a cloud provider's SLAs were not met and on what dates and times. Incident information may include the number of incidents reported for a particular cloud computing environment 104-106 and how long responses to those incidents have been received or outstanding. An example of detailed availability and incident information display is shown in FIG. 5.

The cloud user display depicted in FIG. 4 is provided as an example where a cloud provider has chosen to focus on the incident and availability aspects of an SLA. In one embodiment, the cloud user display 400 could be modified to include other aspects of an SLA that a cloud computing provider (or a cloud provider's consumer) might consider to be important such as performance, disaster recovery or other attributes called out in the SLA. The dashboard 400 may further include the length of duration that each of the SLAs has been negotiated for as well as the provider's performance against those SLAs, based on information contained in the consumer monitor databases 320. These capabilities may be provided from the cloud analyzer hot link 472.

FIG. 5 illustrates an example user screen 500 that displays performance information for a cloud computing environment under a service level agreement between a cloud consumer and a cloud provider. As an example, the user screen shows details on recent reported incidents on the cloud provider B's cloud environment, and incident resolution times for service level agreement Number 1 that is being serviced by the cloud provider B. In the “Availability Details” window 561, the user screen 500 shows that during the reporting period, the cloud computing environment provided by cloud provider B was not available to the cloud consumers on three different occasions. Also displayed are the dates and times during which the cloud computing services were unavailable.

The user screen 500 further shows in an “Incident Details” window 562 that there were five reported incidents associated with the service level agreement Number 1 being serviced by the cloud provider B during the reporting period. The “Incident Details” window 562 further lists the date and time when each incident was reported, and the date and time when the incident was resolved.

FIG. 6 is a flow chart of an example process 600 for setting up multi-cloud monitor components in the cloud computing environments and consumer computer to monitor the performance of the cloud environments, in accordance with aspects of the invention. The process 600 may begin at step 601 with the deployment of the heartbeat monitors 324-325 and incident sub-monitors 334-335 respectively in the cloud computing environments 104-105. The heartbeat monitors 324-325 and incident sub-monitors 334-335 are parts of the provider multi-cloud monitor 214-215, as described above with reference to FIG. 3.

The process 600 may include deploying a provider interface 321, data importer 322, and cloud data analyzer 335 on a cloud consumer's computer system, at step 602. The provider interface 321, data importer 322, and cloud data analyzer 335 are parts of the consumer multi-cloud monitor 211, as described above with reference to FIG. 3. While the cloud consumer 210 is receiving computing services from the providers of the cloud environments 104-105, the heartbeat monitors 324-325 and incident sub-monitors 334-335 collect performance data on the cloud computing environments 104-105 and periodically send the collected cloud performance data to the consumer multi-cloud monitor 211, per step 603.

The provider interface 321 receives performance data imported from the cloud environments 104-105 and stores pertinent information in the consumer cloud database 320 for subsequent analysis, in step 604. The cloud analyzer 323 is leveraged by monitor user experience 212 to perform analytics on the data stored in the consumer cloud database 320. analysis may include comparing the imported cloud performance data against the requirements of the service level agreements that the cloud consumer 210 has established with the cloud providers. The data importer 322 may retrieve information about the service level agreements from the databases 464-465 maintained by the cloud computing environments 104-105.

The cloud performance data and analysis results may be maintained in the cloud consumer's local database 320 for later display and other uses by the cloud consumer 210. The consumer multi-cloud monitor 211 may display (at step 607) the cloud performance data and analysis results to a user, for example, in the form of cloud availability and incident details, as described with reference to FIGS. 4-5.

The subject matter described above is provided by way of illustration only and should not be construed as limiting. Various modifications and substitutions of the described components and operations can be made by those skilled in the art without departing from the spirit and scope of the present invention defined in the following claims, the scope of which is to be accorded the broadest interpretation so as to encompass such modifications and equivalent structures. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, a “memory stick”, optical media, magneto-optical media, CD-ROM, etc.

As will be appreciated by one skilled in the art, aspects of the present invention may be embodied as a method, system or computer program product. Accordingly, aspects of the present invention may take the form of a hardware embodiment or an embodiment combining software (including firmware, resident software, micro-code, etc.) and hardware aspects that may all generally be referred to herein as a “circuit,” “component” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), Ethernet, SCSI, iSCSI, Fibre Channel, Fibre Channel over Ethernet, and Infiniband, or the connection may be made to an external computer, for example, through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

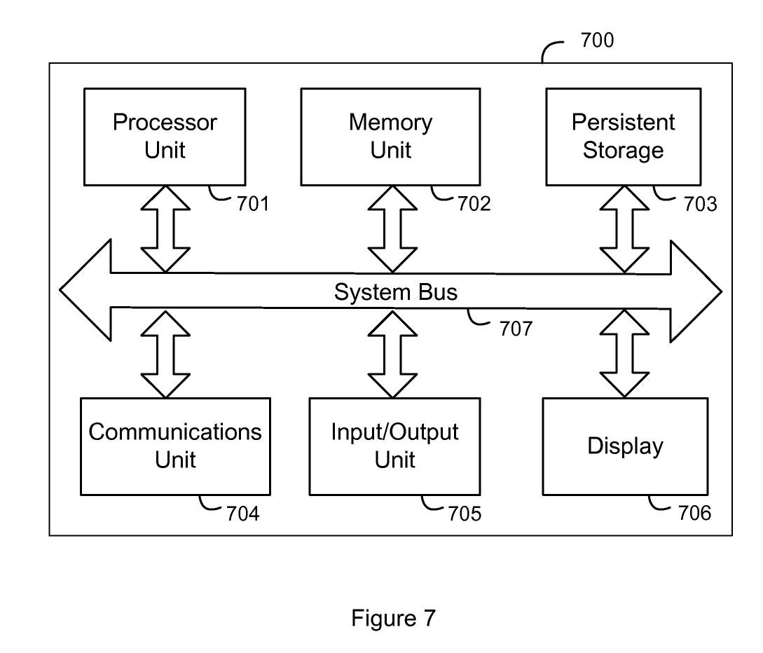

FIG. 7 illustrates an exemplary block diagram of a computer 700 which may be configured to provide the components and operations described with reference to FIGS. 1-6. Computer system 700 may include a processor unit 701, a memory unit 702, a persistent storage 703, a communications unit 704, an input/output unit 705, a display 706 and a system bus 707. Computer programs are typically stored in persistent storage 703 until they are needed for execution by an operating system, at which time the programs are brought into the memory unit 702 so that they can be directly accessed by the processor unit 701.

The processor unit 701 selects a part of memory unit 702 to read and/or write by using an address that the processor 701 gives to memory 702 along with a request to read and/or write. Usually, the reading and interpretation of an encoded instruction at an address causes the processor 701 to fetch a subsequent instruction, either at a subsequent address or some other address. The processor unit 701, memory unit 702, persistent storage 703, communications unit 704, input/output unit 705, and display 706 interface with each other through the system bus 707. An operating system manages the operation of the computer 700 and its interactions with hardware and software components that are connected to the computer 700. One or more applications may be running in the computer 700 to provide services and data to users of the computer 700 and applications running on the computer 700.

The flowchart and block diagrams in the figures described above illustrate the architecture, functionality, and operation of possible implementations of systems, methods and computer program products according to various embodiments of the present invention. In this regard, each block in the flowchart or block diagrams may represent a component, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A multi-cloud monitor system, comprising:
a plurality of provider multi-cloud monitors configured in respective cloud computing environments to obtain performance data on the cloud computing environments;
a consumer multi-cloud monitor configured in a cloud consumer computer to retrieve the cloud performance data from the provider multi-cloud monitors; and
a user interface coupled to the consumer multi-cloud monitor to present the cloud performance data to a user.

2. The system of claim 1, wherein each provider multi-cloud monitor comprises a heartbeat sub-monitor for monitoring the availability of the respective cloud computing environment and an incident sub-monitor for monitoring system incidents of the respective cloud computing environment.

3. The system of claim 2, wherein the heartbeat sub-monitor is coupled to a system manager that manages the operation of the respective cloud computing environment.

4. The system of claim 2, wherein the incident sub-monitor is coupled to an incident manager that manages system incidents in the respective cloud computing environment and maintains information on the system incidents.

5. The system of claim 2, wherein the consumer multi-cloud monitor comprises a provider interface for communicating with the heartbeat sub-monitors and the incident sub-monitors of the provider multi-cloud monitors.

6. The system of claim 1, wherein each cloud computing environment comprises a database that includes performance data of said each cloud computing environment, and the consumer multi-cloud monitor comprises a data importer for retrieving the performance data of said each cloud computing environment.

7. The system of claim 1, wherein the consumer multi-cloud monitor comprises a cloud analyzer for analyzing the performance data retrieved from the cloud computing environments.

8. The system of claim 1, wherein the consumer multi-cloud monitor comprises a database for storing the performance data of the cloud computing environments.

9. The system of claim 1, wherein the consumer multi-cloud monitor comprises a monitor user experience component for formatting the retrieved cloud performance data into a user presentation format.

10. A computer-implemented method for monitoring the performance of cloud computing environments, comprising:
configuring a plurality of provider multi-cloud monitors in respective cloud computing environments to obtain performance data on the cloud computing environments;
configuring a consumer multi-cloud monitor in a cloud consumer computer to retrieve the cloud performance data from the provider multi-cloud monitors;
periodically retrieving the cloud performance data from the provider multi-cloud monitors;
converting the cloud performance data into a format for analysis;
analyzing the converted cloud performance data; and
presenting the analyzed cloud performance data to a user.

11. The method of claim 10, wherein each provider multi-cloud monitor comprises a heartbeat sub-monitor for monitoring the availability of the respective cloud computing environment and an incident sub-monitor for monitoring system incidents of the respective cloud computing environment.

12. The method of claim 10, wherein the heartbeat sub-monitor is coupled to a system manager that manages the operation of the respective cloud computing environment, and the incident sub-monitor is coupled to an incident manager that manages system incidents in the cloud computing environment and maintains information on the system incidents.

13. The method of claim 10, wherein the consumer multi-cloud monitor comprises a provider interface for communicating with the heartbeat sub-monitors and the incident sub-monitors of the provider multi-cloud monitors.

14. The method of claim 10, wherein the presented cloud performance data comprise cloud availability and incident information.

15. The method of claim 10, wherein the presented cloud performance data comprise data on service level agreements with the cloud computing providers.

16. A computer-program product for monitoring the performance of cloud computing environments, the computer-program product comprising a computer readable storage medium embodying program instructions executable by the computer to:
obtain performance data on the cloud computing environments;
periodically retrieve the cloud performance data from the provider multi-cloud monitors;
convert the cloud performance data into a format for analysis;
analyze the converted cloud performance data; and
present the analyzed cloud performance data to a user.

17. The computer-program product of claim 16, wherein each provider multi-cloud monitor comprises a heartbeat sub-monitor for monitoring the availability of the respective cloud computing environment and an incident sub-monitor for monitoring system incidents of the respective cloud computing environment.

18. The computer-program product of claim 16, wherein the consumer multi-cloud monitor comprises a provider interface for communicating with the heartbeat sub-monitors and incident sub-monitors of the provider multi-cloud monitors.

19. The computer-program product of claim 16, wherein the consumer multi-cloud monitor comprises a monitor user experience component for formatting the retrieved performance data into a user presentation format.

20. The computer-program product of claim 16, wherein the presented cloud performance data comprise data on service level agreements with the cloud providers.
